(19) United States
(12) Patent Application Publication
(10) Pub. No.: US 2006/0115693 A1
(43) Pub. Date: Jun. 1, 2006

(54) Test station for a fuel cell power module

(76) Inventors: Akos Toth, Etobicoke (CA); Todd A. Simpson, Brampton (CA); Stephen Burany, Thornhill (CA)

Correspondence Address: BERESKIN AND PARR, 40 KING STREET WEST, BOX 401, TORONTO, ON, M5H 3Y2, CA

(21) Appl. No.: 11/079,733

(22) Filed: Mar. 15, 2005

Related U.S. Application Data
(60) Provisional application No. 60/552,715, filed on Mar. 15, 2004.

(51) Int. Cl. H01M 8/00; H01M 2/02; G06F 19/00

(52) U.S. Cl. 429/13; 702/108; 429/34

(57) ABSTRACT

Aspects of the invention relate to a test station for a fuel cell power module (FCPM). The fuel cell power module has at least one fuel cell therein and a FCPM controller. The test station includes a test controller arranged to communicate with the FCPM controller to determine performance of the FCPM under a simulated load. The test station and FCPM may be arranged in various combinations and configurations for testing one or more FCPM's. One embodiment relates to a master-slave arrangement in which a master controller controls a number of slave test stations, each slave test station being arranged to test a respective power module under a simulated load

### RELATED APPLICATIONS

This application is related to, and claims the benefit of priority from, U.S. Provisional Patent Application Ser. No. 60/552,715, filed Mar. 15, 2004, the contents of which are hereby incorporated by reference.

### FIELD OF THE INVENTION

The present invention relates generally to a test station for a fuel cell power module and systems and methods employing such a test station.

### BACKGROUND OF THE INVENTION

Fuel cell systems are seen as an increasingly promising alternative to traditional power generation technologies, at least in part due to their low emissions, high efficiency and ease of operation. Generally, fuel cells operate to convert chemical energy into electrical energy. One form of fuel cell employs a proton exchange membrane (PEM), where the fuel cell comprises an anode, a cathode and a selective electrolytic membrane disposed between these two electrodes.

In a catalyzed reaction, a fuel such as hydrogen is oxidized at the anode to form cations (protons) and electrons. The proton exchange membrane facilitates the migration of protons from the anode to the cathode. The electrons cannot pass through the membrane and are forced to flow through an external circuit, thus providing an electrical current. At the cathode, oxygen reacts at the catalyst layer with electrons returned from the electrical circuit to form anions. The anions formed at the cathode react with the protons that have crossed the PEM to form liquid water as the reaction product, known as product water.

Fuel cell systems normally employ a series of fuel cells together in what is called a fuel cell stack. Prior to installing a fuel cell stack in a fuel cell-based power generation system, it is necessary to first test the stack to ensure that it will operate within the appropriate operating parameters.

Testing systems for fuel cells have been developed. One such testing system is the fuel cell automatic test station (FCATS), developed by Hydrogenics Corporation. The FCATS is a sophisticated testing system which allows the fuel cell stack to be tested in isolation. The FCATS provides a comprehensive range of tests and provides full process feeds, ensures an appropriate operating environment (e.g. appropriate humidity levels of the air supply to the cathode) and monitoring of various process parameters and conditions. The FCATS is designed for testing fuel cell stacks which are themselves unsophisticated. That is, the fuel cell stacks do not have any capability of self-monitoring or regulating and are not configured to communicate with the FCATS.

As part of a recent development in fuel cell technology, fuel cell stacks have been incorporated into a newly developed fuel cell power module (FCPM). The FCPM adds sophistication to the fuel cell stacks and allows the sensitive operating requirements of the fuel cell system to be packaged for installation in direct commercial applications, such as for powering automotive applications including buses and golf carts. The FCPM has its own controller and is configured to monitor and regulate operation of the fuel cell stack, at least to some extent. The FCPM still, however, relies on an external supply of reactant gases and coolant, as well as a regulated power supply.

Concurrent with the development of the FCPM, there has arisen a need for testing of this more sophisticated fuel cell power generation product.

It is an object of the present invention to provide a test station and corresponding testing method, system and apparatus for a fuel cell power module.

### SUMMARY OF THE INVENTION

One aspect of the invention relates to a test station for a fuel cell power module (FCPM), which comprises at least one fuel cell and a FCPM controller. The test station comprises a test controller arranged to communicate with the FCPM controller to determine performance of the FCPM under a simulated load. Preferably, the simulated load is an automated simulated load. Preferably, the test station is physically discrete and/or separable from the FCPM.

In another aspect, the invention relates to a test station for a plurality of fuel cell power modules, each FCPM comprising at least one fuel cell and a FCPM controller. The test station comprises a test controller arranged to communicate with the FCPM controller of each FCPM to determine performance of the FCPM's under a simulated load.

In another aspect, the invention relates to a test system for a plurality of fuel cell power modules, where each FCPM comprises at least one fuel cell and a FCPM controller. The test system comprises a master test station having a master controller and a plurality of slave test stations each having a slave controller. Each slave controller is arranged to communicate with a respective FCPM controller of the plurality of FCPM's to determine performance of a respective FCPM under a respective simulated load and to communicate with the master controller. The master controller is arranged to communicate with each of the plurality of slave controllers to determine the performance of the plurality of FCPM's.

In another aspect, the invention relates to a test station in combination with a fuel cell power module. The fuel cell power module comprises at least one fuel cell and a FCPM controller and the test station comprises a test station controller arranged to communicate with the FCPM controller to determine performance of the FCPM under a simulated load.

In yet another aspect, the invention relates to a method of testing a fuel cell power module comprising at least one fuel cell and a FCPM controller. The method comprises providing, at a test station in communication with the FCPM, a simulated load; transmitting from a test controller of the test station at least one operation command to the FCPM controller; and receiving at the test controller test data from the FCPM relating to performance of the FCPM under the simulated load.

In still another aspect, the invention relates to a testing apparatus for testing a fuel cell power module (FCPM), which comprises at least one fuel cell and a FCPM controller. The apparatus comprises a test station having a test controller and a simulated load for receiving current from the FCPM and a communication link between the test controller and the FCPM controller. The test controller is configured to communicate with the FCPM controller across the communication link to determine performance of the FCPM during supply of current from the FCPM to the simulated load.

Advantageously, embodiments of the invention provide a test station having reduced functionality (relative to the FCATS, for example) but providing significant test data capture capabilities. Particularly advantageously, the test station of the invention is specifically adapted to interface with the newly developed FCPM. Because of the greater sophistication of the FCPM relative to the bare fuel cell stack for which the FCATS was employed, the test station of the present invention is specifically adapted to communicate with the FCPM and to gather test data relating to the performance of the FCPM as a whole. For example, the FCPM includes a microcontroller programmed to receive data inputs from sensors within the FCPM and to detect faults and other operating conditions, whereupon the FCPM microcontroller communicates this information to the test station during testing.

A further advantage of the test station according to embodiments of the invention is that the test station is adapted to test the functionality of the FCPM as an entire module. In contrast, the FCATS is directed to testing the fuel cell stack as a component, which is a smaller part of the system hierarchy needed for operating a full fuel cell power generation system.

Further advantageously, according to certain embodiments of the invention, the test station can be operated as an on-site slave controller in communication with a remote master computer system in a master-slave configuration. This kind of master-slave configuration enables multiple fuel cell power modules to be tested simultaneously by multiple slave test stations under the control of a single master controller, where the master controller may be located on-site with the power modules under test or may be remotely located from one or more of the power modules.

### BRIEF DESCRIPTION OF THE DRAWINGS

Preferred embodiments of the invention are hereinafter described in further detail, by way of example only, with reference to the drawings, in which:

FIG. 1 is a schematic diagram of a test system, according to one embodiment of the invention, for a fuel cell power module;

FIG. 2 is a schematic diagram of a test system, according to another embodiment of the invention, for a fuel cell power module;

FIG. 3 is a block diagram of a test arrangement for an operation process according to an embodiment of the invention;

FIGS. 4A and 4B are block diagrams of example system operation commands;

FIG. 4C is a block diagram of an example system setup command;

FIG. 5 is a block diagram of an example information record for transmission from the power module to a test station;

FIG. 6A and FIG. 6B are diagrams of example test data records for transmission from the power module to the test station;

FIG. 7 is a block diagram of a test system according to another embodiment of the invention for testing multiple power modules through multiple slaved test stations; and

FIG. 8 is a block diagram of a test system according to yet another embodiment of the invention for testing power modules in parallel.

### DETAILED DESCRIPTION OF THE PREFERRED EMBODIMENT

Throughout this specification and in the drawings, like reference numerals are used to indicate like elements, components or features. Additionally, where elements share a reference numeral shifted by a factor of 100 (e.g., 20, 720 and 820), this indicates a similar functionality of those elements across the various embodiments.

In the following description of preferred embodiments of the invention, it is to be understood that features or functions described in relation to one embodiment may be employed in relation to another embodiment, where appropriate, and all such combinations are hereby specifically incorporated herein.

In order to avoid obscuring the invention, this description will not address the operation of fuel cells or fuel cell stacks in detail, nor will this description address chemical process aspects of fuel cell operation.

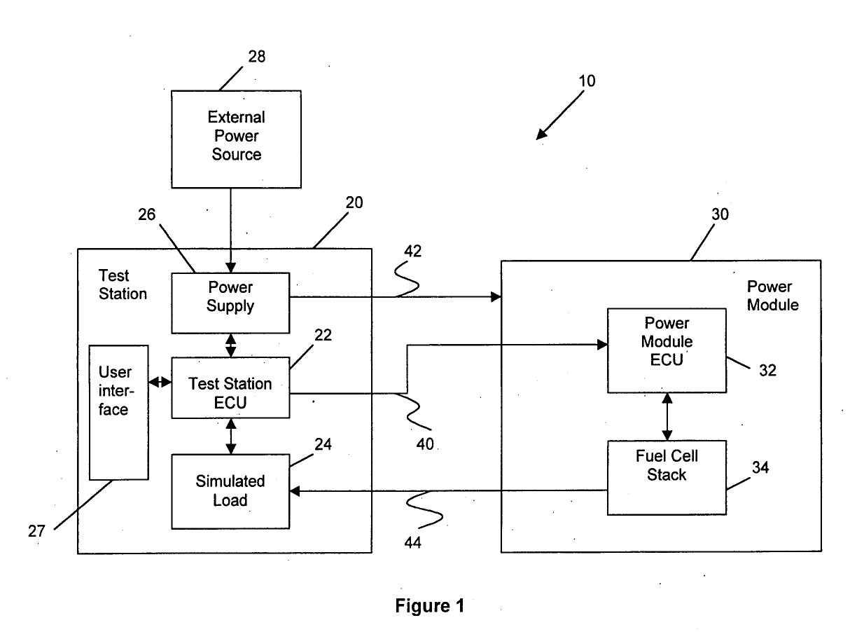

Referring to FIG. 1, a first embodiment of the invention is shown in the form of a test system 10, comprising a test station 20 and a power module 30. An electronic control unit (ECU) 22, which will be referred to herein as the test controller 22, is in communication with an ECU 32 of the power module, which will be referred to herein as the FCPM controller 32. This communication is enabled by a controller area network (CAN) bus 40 interconnecting the test controller 22 and FCPM controller 32 via wiring connectors (not shown) of the respective controllers. The CAN bus conforms generally to the known CAN standard for automotive applications.

The use of the CAN bus 40 in the preferred embodiments is advantageous because, once the test station 20 has tested the FCPM 30, the FCPM 30 can then be installed in an automotive application where the CAN bus 40 is connected to a vehicle master controller. The CAN bus 40 is a two-wire differential serial bus system, which operates in noisy electrical environments with a high level of data integrity. It is capable of high-speed data transmission, in the order of 1 mbps, over short distances.

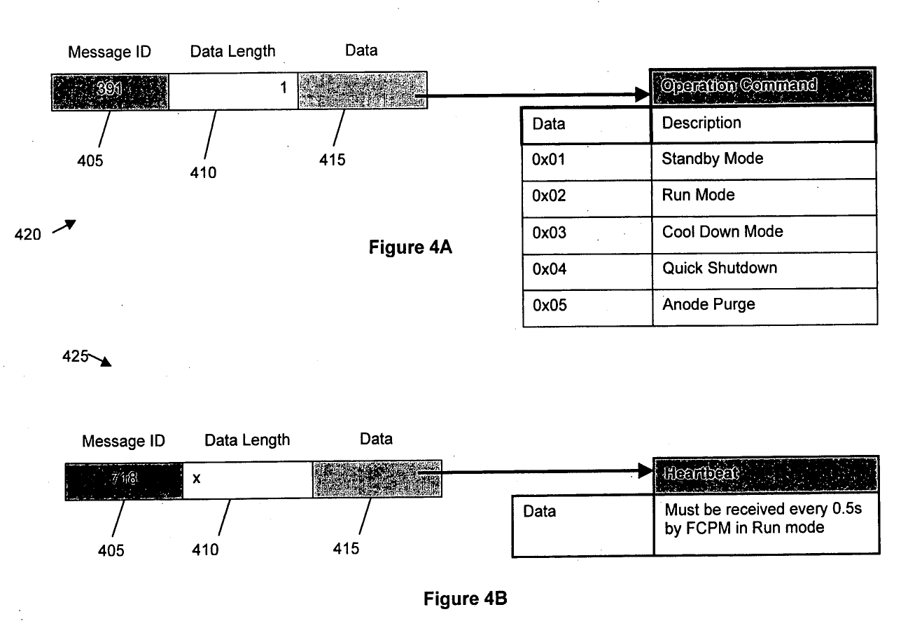

Test controller 22 provides overall control of the test station 20, as well as managing communication with the power module 30 to control operation thereof. Data communication between test controller 22 and FCPM controller 32 via CAN bus 40 will be described in further detail below, in relation to FIGS. 4A, 4B, 5, 6A and 6B. Test station 20 also includes a power supply module 26 for supplying power to all of the test station components and to power module 30. Power supply module 26 receives power from an external power source 28, such as three phase 400V/20A AC.

Power supply module 26 includes transformers and/or rectifying circuitry (not shown) for converting the external power supply to levels suitable for driving the test station components and power module 30 components. A power cable 42 interconnects power supply module 26 with power module 30 to provide separate 12 and 380 Volt DC supplies. Cable 42 may include one or more conductors for this purpose.

The 12 volt DC supply is used for running sensors and monitoring equipment, as well as control circuitry on both the test station 20 and power module 30. Power supply module 26 also provides 24 volts DC for auxiliary functions, for example such as an emergency stop switch (not shown), which disables power supply on cable 42 when it is desired to immediately shut down power module 30. Further voltage supply levels required within test station 20 or power module 30 are derived from the 12, 24 or 380 volt DC supplies. The 380 volt supply is used, for example, for reactant gas blowers in the power module 30.

Test station 20 further includes a simulated load module 24, which draws current from fuel cell stack 34 in power module 30, when the power module 30 is running in a normal power generation mode. Simulated load module 24 effectively converts the electrical energy received from fuel cell stack 34 into heat energy, which is dissipated with the aid of a known heat rejection process, such as cooling water.

Simulated load module 24 may include a bank of load boxes, each box drawing a portion of the current supplied from the fuel cell stack 34. Depending on the power supplied by power module 30, one or more such load boxes, combined as a load bank, may be used to dissipate the electrical load supplied to load module 24. A suitable load box for a 10 kw power module is one rated for 100V, 1000 A, 12 kw and is water cooled. Output power cable 44 is used to deliver output power from fuel cell stack 34 to simulated load module 24. The simulated load module is controlled by test controller 22 so as to draw current from fuel cell stack 34 according to a user-specified or default load profile. Thus, the load profile may be made to vary over time, as desired.

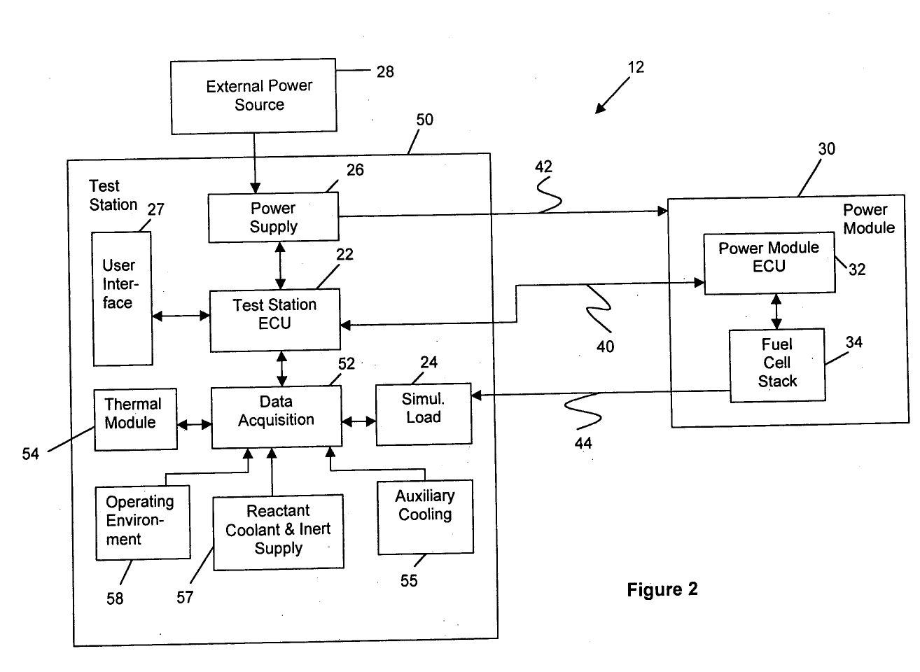

Control and supply of coolant to fuel cell stack 34 is provided externally of test station 20, in this embodiment. However, in the embodiment shown and described in relation to FIG. 2, supply of coolant is controlled and monitored by test controller 22.

Test station 20 further includes a user interface 27, including, for example, a display and keyboard, as well as any other user interface devices which may be appropriate for assisting the user to observe and govern the testing of power module 30. Test station stores and executes appropriate software for facilitating user input and display output, as well as providing graphics and data logging features.

Test controller 22 communicates with simulated load module 24, power supply module 26, and user interface 27 to operate the test station 20. Test controller 22 receives power from power supply module 26 and checks that power is being supplied to power module 30 and the appropriate components of test station 20. Test controller 22 also communicates with simulated load module 24 to monitor and control heat rejection (i.e. dissipation) within the load module 24 when it is drawing current from the fuel cell stack 34. Test controller 22 is further configured to receive input from relevant input devices comprised in user interface 27, such as a keyboard or mouse, and to provide display signals to a display for the user to observe graphical representations of the test data gathered during testing of the FCPM.

In a preferred form, test controller 22 comprises a computer processor such as a Pentium 4 microprocessor made by Intel Corporation, or equivalent. The computer processor must have sufficient capability to efficiently run control and monitoring software for operation of the test station 20 and have access to standard computer peripherals, including fast and slow (volatile and non-volatile) memory. Test controller 22 preferably runs suitable LabVIEW software for automation and data logging, made by National Instruments Corporation, although other suitable automation and data logging software may be used instead. Test controller 22 comprises, or has access to, a memory (not shown), in which are stored the data gathered during the testing of the FCPM, as well as computer program instructions for causing the test controller 22 to perform the testing methods and procedures described herein.

In order to perform appropriate control and monitoring functions within power module 30, FCPM controller 32 is arranged to control and/or monitor certain internal functions. For example, power module 30 preferably controls the flow and pressure of reactants to fuel cell stack 34. Further, the power module may include temperature sensors, such as thermistors or thermocouples, and some form of humidification means for humidifying the reactant gases prior to provision thereof to fuel cell stack 34. Power module 30 may also have exhaust outlets or drains for exhausting reactant gases, as well as water byproduct (e.g. through a suitable drain), either through test station 20 or from power module 30 directly.

Power module 30 may also include a voltage monitor (not shown) for monitoring the cell voltages of fuel cell stack 34. A suitable voltage monitor is described in commonly owned co-pending U.S. patent application Ser. No. 09/865,562, filed May 29, 2001, the contents of which is hereby incorporated by reference. U.S. patent application Ser. No. 09/865,562 is published under US Patent Publication No. 2002-0180447-A1. The voltage monitor monitors the voltage level of each cell in fuel cell stack 34 as it varies over time and provides the gathered information to FCPM controller 32 for transmission to test controller 22 along with other test data.

FCPM controller 32 may be an embedded controller such as the CMOS 16 bit 20 MHz C167C microcontroller made by Infineon Technologies AG.

Referring now to FIG. 2, a second embodiment of the invention is depicted, in the form of test system 12. Test system 12 is similar to test system 10 shown and described in relation to FIG. 1, but has a test station 50 with enhanced functionality relative to previously described test station 20. In the following description of FIG. 2, reference will only be made to those aspects of test station 50 which are different from test station 20 as described above. Thus, for example, for a description of the interaction between the test controller 22 and FCPM controller 32 over CAN bus 40, reference should be made to the corresponding description with respect to FIG. 1 above.

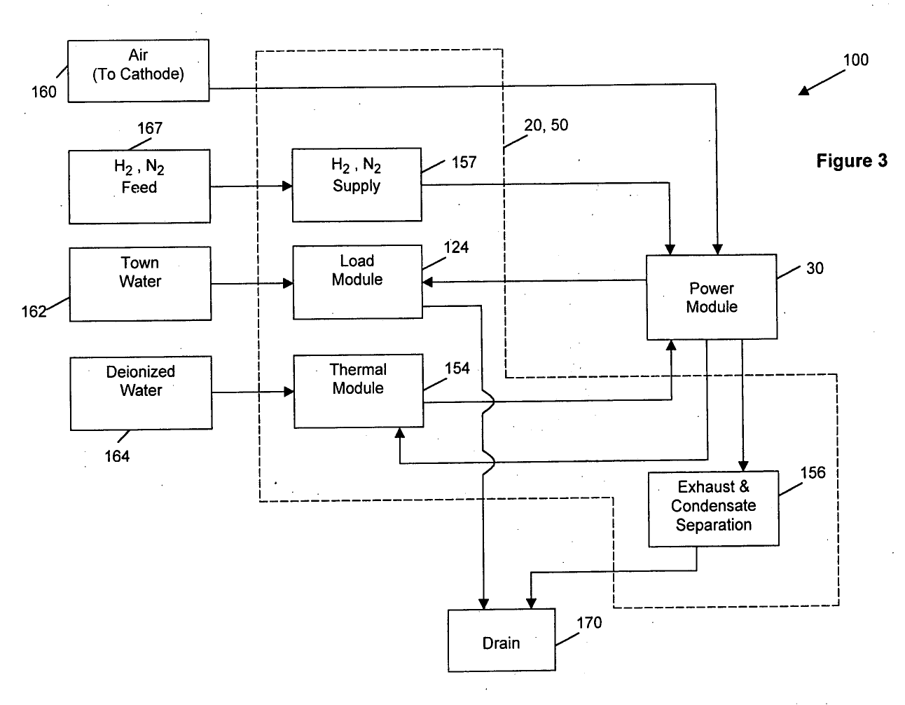

Test station 50 is a more enhanced and sophisticated version of test station 20 in that it includes a data acquisition module 52 for interfacing with additional monitoring and control modules within test station 50. The primary function of data acquisition module 52 is to receive analog inputs from various sensors associated with the additional modules and to convert these to digital form and communicate the digitized data to test controller 22.

Where needed, data acquisition module 52 can receive digital signals from test controller 22 and convert these to analog outputs to effect control of devices (for example, such as a pump, fan, flow control device, solenoid valve, etc.) within test station 50. For example, a thermal module 54 is preferably provided, which may include multiple thermistors (not shown) along a cooling line (not shown) for sensing the temperature of coolant supplied to the fuel cell stack 34 (described further in relation to FIG. 3 below). Additionally, in order to control coolant flow within the cooling line, test controller 22 provides an output control signal to data acquisition module 52, which in turn provides an analog output control signal to a pump and/or other control devices in the cooling line via thermal module 54. It will be understood that, as required, the data acquisition module can be configured to accept digital and/or analog signals for each of the various inputs and outputs that it is to process.

Thermal module 54 includes one or more flow sensors (not shown) along the cooling line for monitoring coolant flow. If the output of a flow sensor in thermal module 54 indicates that there is no coolant flow, for example, the test controller 22 may command the power module 30 to shut down.

In addition to the thermal module 54, the test station 50 includes an auxiliary cooling module 55 for monitoring the provision of coolant, such as town water, to load boxes within simulated load module 24 to assist in heat rejection. Data acquisition module 52 receives input from a flow sensor or meter (not shown) within auxiliary cooling module 55 to indicate that heat rejection coolant is flowing.

Other suitable flow control and monitoring devices (not shown) are included within auxiliary cooling module 55 to ensure that the load boxes receive adequate cooling when simulated load 24 draws current from power module 30. Reactant and inert gas module 57 monitors supply of reactant and inert gas to power module 30 using gas flow and pressure sensors (not shown) in separate reactant and inert gas input lines. The reactant gas here preferably includes Hydrogen as a fuel gas, which is only supplied to the anode. Air may be supplied to the cathode of each fuel cell in the stack as the other reactant gas. The output of the monitoring sensors of reactant and inert gas module 57 is provided to data acquisition module 52.

Sensors monitoring pressure, temperature and relative humidity of the operating environment are included within operating environment module 58, which supplies the sensor output data to data acquisition module 52 for processing and monitoring by the test controller 22. Because the reactant gas supplied to the cathode may be ambient air taken from the operating environment, it is important to measure the pressure, temperature and relative humidity levels of the air in the operating environment.

FIGS. 1 and 2 illustrate interaction between the various modules described in relation thereto in an electrical, control or data communication sense, rather than in a chemical process sense. Generally, each module has some sensing or control equipment associated therewith and generates or receives an electrical signal which relates to a sensed or commanded process parameter. FIG. 3, as described below, generally illustrates the process interaction between the modules of the FCPM 30 and the test station 20 or 50, for the purpose of describing the technical context in which embodiments of the invention operate.

Referring now to FIG. 3, there is shown a test arrangement 100 for carrying out a test operation process. In test arrangement 100, air 160 is input, by means of one or more blowers (not shown) and through at least one filter (not shown), to the cathode of power module 30 as part of the reactant supply. Hydrogen or Hydrogen-rich hydrocarbon reformate feed is supplied to test station 20 or 50 by H₂, N₂ feed 167. H₂, N₂ feed 167 may alternatively be used as a feed for inert gas, such as nitrogen, for purging reactant (fuel) gas from the anode. A gas supply control module 157 within test station 20 receives the H₂ or N₂ feed from feed supply 167 and controls the pressure, humidity and flow rate of fuel or inert gas to the anode of the fuel cell stack 34 within power module 30.

Load module 124 within test station 20 includes one or more load boxes for dissipating heat energy from the power module and, for this purpose, receives cooling water, such as town water 162 from an external (public) water supply. The water used in this way by load module 124 is drained in drain 170. Town water 162 is preferably filtered by at least a coarse filter (not shown) prior to provision to load module 124.

Thermal module 154 within test station 20 receives deionized water 164, supplies it to power module 30 as a coolant and receives expended coolant from power module 30 in return. Thermal module 154 cools the expended coolant using a heat exchanger (not shown) and tops it up with further deionized water 164, where necessary.

Anode and cathode exhaust gases are vented and condensate is separated therefrom at exhaust and condensate separation module 156, either as part of test station 20 or 50 or as a separate auxiliary function. Separated condensate is provided to drain 170.

In order for the FCPM controller 32 and the test controller 22 to effectively communicate in relation to performance testing and control of the FCPM 30, a data exchange structure is established.

Referring now to FIGS. 4A, 4B and 4C, test controller 22 is programmed to issue system operation (420, 425) and set-up (430) command messages to FCPM controller 32. These commands 420, 425, 430 include a message identifier (ID) field 405, a data length field 410 indicating the data length (in bytes) of the data message and at least one data field 415 carrying the data payload.

Message ID field 405 indicates the kind of command that is being transmitted. The data length and the format of data fields in the message vary according to the kind of message specified by the message ID. For example, message ID # 391 in command message 420 may indicate an operation command, while message ID # 718 in command message 425 may indicate a heartbeat signal from test controller 22, transmitted during a run mode in which current is supplied by fuel cell stack 34.

The heartbeat signal must be received periodically by FCPM controller 32 in the run mode, for example every 0.5 seconds, or the FCPM will revert to a stand-by mode. Other suitable heartbeat periods may be chosen for particular testing requirements. Set-up command 430 is commonly a current draw request, where the data field 415 indicates the amount of current which test station 20 wishes to draw from fuel cell stack 34.

Because the FCPM 30 can operate in one of several modes, the test controller 22 is programmed to transmit a system operation command message 420 to FCPM controller 32 so as to indicate the mode in which the FCPM 30 should be operated. Examples of such operation modes include: a run mode, a standby mode, a cool down mode, a quick shut down and an anode purge.

In the standby mode, the FCPM 30 may be either warming up the fuel cell stack from a shut down state (i.e. when it is turned off) or the FCPM 30 may be in an operative state but is awaiting receipt of a further command from test controller 22.

In the run mode, the FCPM 30 is operational and is supplying current to simulated load module 24. In the run mode, fuel cell stack 34 is operating so as to generate power (by outputting current), through consumption of reactant gases at the anode and cathode sides of each fuel cell within fuel cell stack 34. During the run mode, the FCPM controller 32 may receive one or more set-up commands 430 from test controller 22, each having different current draw requests, so that the current output of fuel cell stack 34 is varied over time according to a desired varying load profile of the stack.

In the cool down mode, the fuel cell stack 34 does not receive further reactant gases, in preparation for the FCPM 30 to be shut down. Coolant continues to flow to the fuel cell stack 34 to cool the fuel cells therein. Some residual current may be output from fuel cell stack 34 during the cool down mode, while the reactant gases remain at the anode and cathode sides of the each of the cells.

The quick shutdown mode is used for quickly shutting down operation of the FCPM 30 in an emergency situation. For example, if the temperature of the fuel cell stack 34 is too high, the fuel cells may be damaged and the FCPM 30 should be quickly shut down. In another example, the quick shutdown mode may be used where a flow sensor in the coolant line indicates that there is no coolant flow to fuel cells within fuel cell stack 34.

In the anode purge mode, an inert gas is used to purge the fuel gas from the anode side of each of the cells within fuel cell stack 34 to ensure that fuel cell stack 34 does not continue to consume reactant gases and generate current. The anode purge mode may be used as part of the cool down procedure or may be performed after the fuel cell stack 34 has cooled down to a certain temperature. It is generally desirable to purge the anode of the cells in fuel cell stack 34, using Nitrogen or any other suitable inert gas, before and after testing of the FCPM 30. In addition to flushing out any reactant gases, the anode purge may serve to flush out residual water or other pollutants in the cells that may adversely affect the performance of the fuel cells, which would in turn adversely affect the performance of the fuel cell stack 34.

In order for the FCPM 30 to begin testing under the simulated load, the test controller 22 issues a system operation command message 420, for example with message ID number 391 in message ID field 405, and a data code in data field 415 designating the run mode. Alternatively, if the test controller 22 wants the FCPM 30 to be operated in another operation mode, the corresponding data code for that operation mode is transmitted in data field 415.

When the FCPM controller 32 receives a system command message 420, 425 or 430 from test controller 22, it first decodes the message ID field 405 to determine the nature of the system command 420, 425 or 430. Depending on the value of the message ID field 405, the FCPM controller 32 will proceed to decode the remainder of the system command message 420, 425 or 430. For example, if the message ID field value is 391, the FCPM controller 32 will proceed to decode the data length field 410 (to determine the number of bytes taken up by the data fields) and data field 415, having recognized the command as an operation mode command from the value of the message ID field 405. The value of the data field 415 will then be used to set the operation mode of FCPM 30.

In another example, if the value of message ID field 405 is 718, for example, FCPM controller 32 will recognize this as a heartbeat message (command message 425). Because the FCPM controller 32 only requires periodic receipt of the heartbeat message, the content of the message is not important. Accordingly, the FCPM controller 32 can disregard the content of the data length field 410 and data field 415.

In a further example, the system command message may be a system setup command 430 for configuring the desired output current level from the FCPM 32 to drive simulated load 24. Thus, for example, a value of 519 in the message ID field 405 may be decoded by FCPM controller 32 and interpreted as a current draw request. Once the FCPM controller 32 has determined that the incoming message is a current draw request, it decodes the data length field 410 and data field 415 to determine the amount of current to be supplied to simulated load 24. The FCPM controller 32 then proceeds to configure the fuel cell stack 34 (by controlling the reactant gas supply, for example) to be able to output the current specified in the data field 415, if possible.

The value of data field 415 in the current draw request may be arranged so that the decimal value corresponding to the binary number in data field 415 is a multiplier of the basic current increment of 0.5 Amps. For example, if data field 415 holds the binary number 1001, this corresponds to the decimal value 9 and the current draw request therefore specifies an output current of 4.5 Amps (which is 9 times 0.5). This example is only one way of arranging and interpreting the data in data field 415 for command message 430. Other suitable methods may be used to indicate a desired current output from the value transmitted in data field 415 with the current draw request.

The current draw request can only be transmitted to the FCPM controller 32 when the FCPM 30 is in run mode. If the test controller 22 transmits a current draw request when the FCPM 30 is in a mode other than the run mode, the FCPM controller 32 responds by transmitting a status message back to the test control 22, indicating that the operation mode of FCPM 30 doesn't correspond to the run mode and, accordingly, current cannot be output from the fuel cell stack 34.

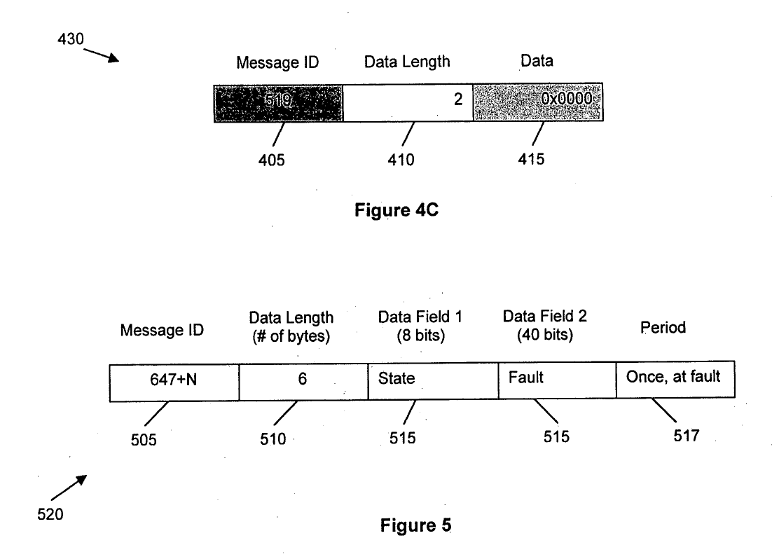

FIG. 5 is a representation of a data record (in the form of a message 520) transmitted by the FCPM controller 32 to test controller 22 to provide information as to FCPM status or faults. Message 520 includes a message ID field 505, a data length field 510 and several data fields 515 for indicating system status and faults. Message 520 is decoded by test controller 22 in a similar way to commands 420 and 430 described above. That is, message field 505 is decoded first, followed by the data length field 510 and then all data fields 515.

At least two data fields 515 are included in message 520 to convey information to test controller 22 as to the status and/or faults of the FCPM 30. For example, one data field 515 may be used for indicating the FCPM's status. The status may be any one of the following:

FCPM Status

| | |
|---|---|
| 1. | Start |
| 2. | Standby |
| 3. | Wait OCV |
| 4. | Wait Output Precharge |
| 5. | Run Mode |
| 6. | Run Mode- Stack Recovery |
| 7. | Cool Down |
| 8. | Fault State |
| 9. | Blower Startup |
| 10. | FCPM Cathode Purge |

Another of the data fields 515 in message 520 defines the actual fault detected, if the status indicated that the FCPM 30 was in a fault state. The data field 515 indicating the fault may be about 40 bits long, for example. Example fault states may be as follows:

FAULT STATE

| NO. | DESCRIPTION |
|---|---|
| 1. | Stack Undervoltage |
| 2. | Coolant Overtemp |
| 3. | H2 Overpressure |
| 4. | Stack Isolation Fault |
| 5. | Output Precharge Fail |
| 6. | Hydrogen Leak |
| 7. | Cathode Saturator Low Speed Fault |
| 8. | External System Emergency Stop |
| 9. | FIT Sensor Out of Range |
| 10. | Current Sensor Out of Range |
| 11. | Coolant Temp Sensor Out of Range |
| 12. | Coolant Pump Relay Fault |
| 13. | Recirculation Pump Relay Fault |
| 14. | Blower Fault |
| 15. | H2 Shutoff Valve Fault |
| 16. | H2 Purge Valve Fault |
| 17. | Cathode Saturator Motor Fault |
| 18. | Water Separator Drain Valve Fault |
| 19. | Pilot Enable Fault |
| 20. | Coolant Pump Relay Overcurrent |
| 21. | Recirculation Pump Relay Overcurrent |
| 22. | Blower Control Signal Short Circuit |
| 23. | H2 Shutoff Valve Overcurrent |
| 24. | H2 Purge Valve Overcurrent |
| 25. | Cathode Saturator Overcurrent |
| 26. | Water Separator Drain Valve Overcurrent |
| 27. | Pilot Enable Overcurrent |
| 28. | Aux Recirculation Relay Fault |
| 29. | Aux Recirculation Relay Short |
| 30. | H2 Low Supply Pressure |
| 31. | 380 V Boost Enable Short |
| 32. | 12 V Buck Enable Short |
| 33. | Overcurrent Fault |
| 34. | Coolant Underflow Fault |
| 35. | Coolant Level Switch Fault |

The fault state descriptions listed in the table above will be understood by those skilled in the art as normal control-related or sensor-related faults, in the context of testing a fuel cell stack and power module having same.

Message 520 preferably includes a timing field 517 for indicating the period of the message.

For data fields 515, the number of bits in each field may correspond to, or exceed, the number of possible states defined by that field. Thus, for example, if the FCPM 30 has 10 different possible states, the corresponding data field 515 for indicating those states may have 10 bits, whereby a particular state is indicated to be applicable when the bit for that state is on or “1” and to be inapplicable when the bit for that state is off or “0”. Alternatively, the number of the state or status indicated by a field may be represented by a binary number corresponding to the state or status number.

Test data, in the form of message 520 (and messages 620, 630 described below), are periodically transmitted from FCPM controller 32 to test controller 22 while the FCPM controller 32 continues to receive the heartbeat signal from test controller 22. The period of transmission of message 520 is preferably the same as, or less than, that of the heartbeat signal. For example, a message 520 may be transmitted to the test controller 22 from the FCPM controller 32 once every 0.05 to 0.5 seconds.

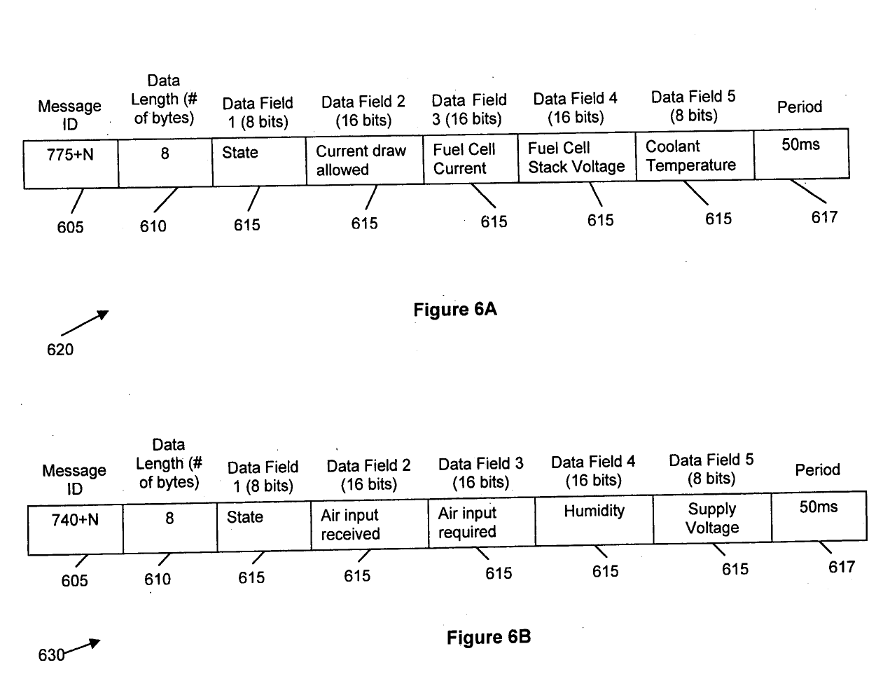

FIGS. 6A and 6B show FCPM information messages 620 and 630, respectively, each having message ID fields 605, data length fields 610, a plurality of data fields 615 and a timing field 617. Information message 620 and 630 are decoded by test controller 22 in a similar manner to the decoding method described in relation to messages 520.

Information messages 620, 630 may be used for conveying operational parameter information from FCPM controller 32 to test controller 22 during testing. For example, the FCPM controller 32 may use an information message to report the allowable current which can be drawn from the fuel cell stack 34 and may indicate the fuel cell current and fuel cell stack voltage. This information is preferably encoded in separate data fields 615 within FCPM information message 620 or 630. Current values may be indicated at a rate of 1 Ampere per bit, while stack voltage may be indicated at a rate of 0.1 Volts per bit, for example. In the example illustrated in FIG. 6A, the coolant temperature is also encoded into one of the data fields 615 of FCPM information message 620. The coolant temperature may be indicated by one degree Celsius per bit, for example.

Each FCPM information message 620, 630 includes a timing field specifying a period after which another message will be transmitted. For example, another such message may be transmitted every 50 milliseconds. FCPM information messages 620, 630 preferably also include a dedicated data field 615 to indicate the FCPM operational status, in a similar manner to that described in relation to FIG. 5.

Information message 630 provides a further example of an information message output from the FCPM controller 32 to test controller 22, but where the content of the data fields 615 is used for different purposes, for example so as to indicate operational parameters such as the air input received by FCPM 30, the required air input, the humidity of the air and/or the supply voltage level received. Other operational parameters may be specified for the contents of data fields 615. FCPM information messages 620 and 630 may be transmitted in sequence or one instead of the other, depending on the data gathering requirements of test controller 22.

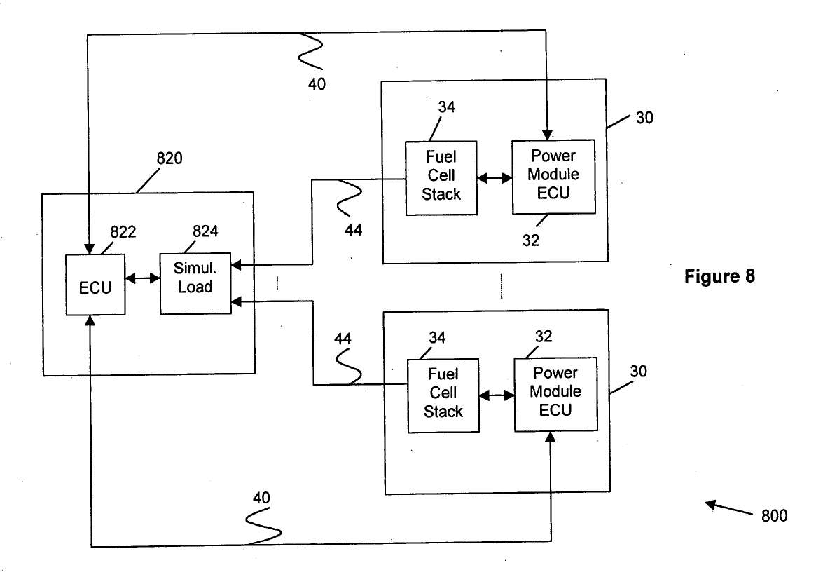

For information messages, such as those described in relation to FIGS. 5, 6A and 6B, where the test controller 22 is used to test several power modules 30 simultaneously (such as is shown in FIG. 8 and described in relation thereto), the value in message ID field 605 or 505 of respective messages 620, 630 or 520 includes an offset N corresponding to a particular one of the multiple power modules 30 under test. Thus, for example, where a test station controls ten power modules 30, the value of N for the first power module may be 0, while for the second power module 30 it may be 1, all the way up to 9 for the tenth power module 30.

Thus, if an information message 620, 630 or 520 from the first power module 30 had a message ID number 775 (i.e. 775+N, where N=0), the second power module 30 would transmit corresponding information messages (i.e. containing the same operational parameters) having a message ID number 776 (i.e. 775+N, where N=1) and the tenth power module 30 would transmit corresponding information messages having a message ID number 784 (i.e. 775+N, where N=9). This offset applied to the message ID field 605, 505 enables the test controller to readily identify which of the multiple power modules is the source of the incoming information message.

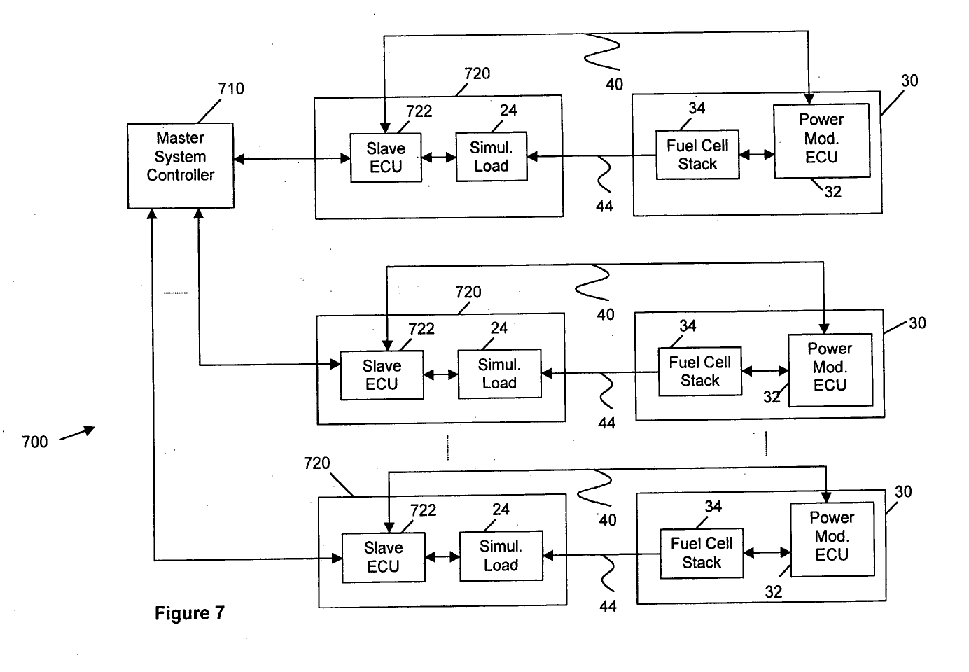

FIG. 7 is a block diagram of a master-slave arrangement of a test system 700, whereby a master system controller 710 is in communication with plural slave test controllers 722 within slave test stations 720 for drawing current from multiple respective power modules 30. Master system controller 710 may be remotely located relative to slave test stations 720 or co-located with one or more of them. Master system controller 710 comprises a computer processor (not shown), preferably running the LabVIEW software mentioned above, and has a user interface capability (not shown) of a similar nature to test stations 20 and 50 shown and described in relation to FIGS. 1 and 2.

In the master-slave arrangement of test system 700, each power module 30 uses the simulated load 24 of each slave test station 720 in a similar manner to that described in relation to FIGS. 1 to 3.

The number of slave test stations 720 in test system 700 depends on the processing capability of the master system controller 710. Thus, with a master system controller 710 having a large data processing power, many slave test stations 720 can be run concurrently so as to test respective power modules 30. This arrangement increases the efficiency of the testing where multiple power modules 30 are required to be tested.

Master system controller 710 communicates with slave test controllers 722 periodically to retrieve the test data records gathered thereby. This may be performed in a polling fashion somewhat slower than the data acquisition of power module performance parameters by the slave test controllers 722, as the master system controller 710 may have less direct responsibility for controlling the power module testing.

In one embodiment of test system 700, slave test controllers 722 may be relatively dumb, without including user interface functionality and thus requiring reduced display and software functionality. Alternatively, slave test stations 720 may have the same functionality as test stations 20 or 50.

Apart from the use of master system controller 710 to interface with multiple slave test controllers 722 within slave test stations 720, the master-slave test system 700 otherwise operates as a series of concurrently running test systems similar to test systems 10 and 12 described in relation to FIGS. 1 and 2, respectively.

FIG. 8 is a block diagram of a test system 800, in which a single test station 820 with a test controller 822 is arranged to test a plurality of power modules 30 in parallel. In order to affect such control, test controller 822 has a suitably powerful processing capability and controls a bank of simulated loads 824 as necessary for drawing the desired amount of current from power modules 30.

Test systems 700 and 800 employ test stations 720, 820 of a similar nature to test stations 20 and 50 shown and described in relation to FIGS. 1 and 2, respectively. For example, test controller 820 is connected to a plurality of power modules 30 by respective CAN Bus 40 connections and receives current from power modules 30 via respective output cables 44. Generally each test station 720, 820 is responsible for providing power (or at least monitoring the provision of power) to the power modules 30.

While the embodiments described above have been described in relation to fuel cells and fuel cell stacks adapted to receive Hydrogen as a fuel gas at the anode and air as a reactant gas at the cathode, it should be understood by persons skilled in the art that alternative electrochemical stack arrangements may be employed, for example, having different fuel cells or fuel cell components or constituents that are based on different electrochemical reactions, without departing from the spirit and scope of the invention. In particular, the described embodiments may be applied to testing electrolyzer cell stacks instead of fuel cell stacks.

While some description has been made of the elements and functions of the test station and power module within test system embodiments, it should be noted that both the test station and power module may be provided with varying functionality and sophistication, without departing from the spirit and scope of the invention. For example, it should be noted that, while the test station requires a controller and a simulated load and the power module requires a fuel cell stack and a controller, other features, such as reactant and coolant supply functionality, for example, may be provided separately. Further, power may be supplied to the fuel cell power module 30 independently of the test station 20, 50, for example. Further, the degree of instrumentation and control exerted over reactants provided to and returned from the fuel cell stack may vary, depending on the desired implementation.

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

We claim:

1. A test station for a fuel cell power module (FCPM), which comprises at least one fuel cell and a FCPM controller, the test station comprising:
a test controller arranged to communicate with the FCPM controller to determine performance of the FCPM under a simulated load.

2. The test station of claim 1, wherein the test station comprises the simulated load and the test controller controls the simulated load during operation of the FCPM.

3. The test station of claim 1 in combination with the FCPM, wherein the test station is physically discrete and/or separable from the FCPM.

4. The test station of claim 1 in combination with the FCPM, wherein the FCPM further comprises one or more of:
reactant flow control means;
pressure control means;
temperature monitoring means;
humidity control means; and
reactant by-product exhaust means.

5. The test station of claim 1, further comprising a controller area network (CAN) bus, wherein, in use of the test station, the test controller and the FCPM controller communicate via the CAN bus.

6. The test station of claim 1, wherein the test controller is programmed to transmit an operation command to the FCPM controller and to receive test data relating to the performance of the FCPM under the simulated load.

7. The test station of claim 6, wherein the test station comprises a memory for storing the received test data.

8. The test station of claim 6, wherein the test controller stores the received test data in a single data file, the data file including at least one data record comprising test data received from the FCPM controller.

9. The test station of claim 6, for use with a FCPM comprising at least one fuel cell stack, where in the test data includes data relating to voltage output of the at least one fuel cell stack.

10. The test station of claim 6, wherein the operation command sets an operation mode of the FCPM.

11. The test station of claim 6, wherein the test controller is further programmed to transmit a current draw request to the FCPM controller in order to receive current at the simulated load.

12. The test station of claim 11, wherein the current draw request includes a data field specifying a current level to be supplied to the simulated load.

13. The test station of claim 6, wherein the test data includes data relating to an operational status of the FCPM.

14. The test station of claim 13, wherein the operational status of the FCPM comprises:
a standby mode;
a run mode;
an anode purge mode; and
a shut-down mode.

15. The test station of claim 1, wherein data communications between the test controller and the FCPM controller comprise one or more data packets, each data packet comprising an identifier and one or more data fields arranged according to the identifier.

16. The test station of claim 1, wherein the simulated load forms part of the test station and the test controller controls the simulated load.

17. The test station of claim 1, wherein the test controller periodically transmits, in use of the test station, a heartbeat signal to the FCPM controller, and wherein, in response to a failure to receive the heartbeat signal within a predetermined time period, the FCPM controller is programmed to initiate a standby mode, in which the FCPM does not supply current to the simulated load.

18. The test station of claim 1, further comprising a power supply module for receiving power from an external power source and for supplying power to the test station and the FCPM.

19. The test station of claim 1, further comprising a thermal module for monitoring and controlling coolant supply to the FCPM.

20. The test station of claim 1, further comprising a data acquisition unit in communication with the test controller, the data acquisition unit being configured to receive multiple analog data inputs and to convert the analog data inputs into digital data inputs to the test controller.

21. The test station of claim 20, wherein the multiple analog data inputs include data input from one or more of:
the simulated load;
a thermal module;
a test station power supply module;
fuel cell reactant supply monitoring means; and
at least one operating environment sensor.

22. The test station of claim 1, wherein the test controller is arranged to control a load profile of the simulated load to vary the load profile during at least a period of performance of the FCPM.

23. A test station for a plurality of fuel cell power modules (FCPM), each FCPM comprising at least one fuel cell and a FCPM controller, the test station comprising:
a test controller arranged to communicate with the FCPM controller of each FCPM to determine performance of each FCPM under a simulated load.

24. The test station of claim 23, wherein the simulated load forms part of the test station and the test controller controls the simulated load.

25. The test station of claim 23, wherein the plurality of FCPMs is connected in series and/or parallel to supply power to the simulated load.

26. The test station of claim 23, wherein the simulated load comprises a plurality of load modules to draw current from the FCPMs.

27. The test station of claim 23, wherein the simulated load is an automated simulated load.

28. The test station of claim 23, wherein the test station is physically distinct and/or separate from each of the plurality of FCPMs.

29. A test system or a plurality of fuel cell power modules (FCPM), each FCPM comprising at least one fuel cell and a FCPM controller, the test system comprising:
a master test station having a master controller; and
a plurality of slave test stations each having a slave controller;
wherein each slave controller is arranged to communicate with a respective FCPM controller of the plurality of FCPMs to determine performance of a respective FCPM under a respective simulated load and to communicate with the master controller; and
wherein the master controller is arranged to communicate with each of the plurality of slave controllers to determine the performance of the plurality of FCPMs.

30. The test system of claim 29, wherein each simulated load forms part of a respective slave test station and the slave controller of each slave test station controls the respective simulated load forming part thereof.

31. A method of testing a fuel cell power module (FCPM) comprising at least one fuel cell and a FCPM controller, the method comprising:
providing a test station including a simulated load and a test controller, and providing communication between the FCPM controller and the test controller;
transmitting from the test controller at least one operation command to the FCPM controller; and
receiving at the test controller test data from the FCPM, relating to performance of the FCPM under the simulated load.

32. The method of claim 31, further comprising the step of:
controlling a load profile of the simulated load to vary the load profile during at least a period of performance of the FCPM.

33. The method of claim 31, further comprising the steps of:
periodically transmitting a heartbeat signal from the test controller to the FCPM controller; and
supplying current from the FCPM to the simulated load in response to continued receipt of the heartbeat signal by the FCPM controller.

34. Testing apparatus for testing a fuel cell power module (FCPM), which comprises at least one fuel cell and a FCPM controller, the apparatus comprising:
a test station having a test controller and a simulated load for receiving current from the FCPM; and
a communication link between the test controller and the FCPM controller;
wherein the test controller is programmed to communicate with the FCPM controller across the communication link to determine performance of the FCPM during supply of current from the FCPM to the simulated load.
